(19) United States
(12) Patent Application Publication
(10) Pub. No.: US 2025/0207376 A1
(43) Pub. Date: Jun. 26, 2025

(54) Fluid Flow Timer

(71) Applicant: TouchGrid Pty Ltd, Perth (AU)

(72) Inventor: Bernard Emby, Perth (AU)

(21) Appl. No.: 18/989,079

(22) Filed: Dec. 20, 2024

(30) Foreign Application Priority Data
Dec. 21, 2023 (AU) 2023904188

(51) Int. Cl. E03C 1/04; G01H 11/08

(52) U.S. Cl. CPC E03C 1/0408; G01H 11/08

(57) ABSTRACT

A fluid flow timing device, including attaching means for attaching the device to a structure having or in mechanical communication with a fluid conduit; a power supply; at least one vibration sensor for periodically acquiring one or more sensed values indicative of an instantaneous sensed vibration of the structure; at least one processor configured to periodically process a set of the one or more sensed values to determine whether the set of the one or more sensed values are indicative of the presence or absence of fluid flow in the fluid conduit, and control an operation of a timer module depending on the determination; and output means for providing an output signal indicating a status of the timer module.

### CROSS-REFERENCE TO RELATED APPLICATION

This application claims priority to Australian Patent Application No. 2023904188 filed Dec. 21, 2023, the disclosure of which is hereby incorporated by reference in its entirety.

### BACKGROUND

### Technical Field

The present disclosure relates to a fluid flow timer. In a particular form the present disclosure relates to a timer for monitoring water use.

### Technical Considerations

Reducing water usage is becoming increasingly important, particularly in regions which are prone to drought or water usage restrictions arising from water scarcity. Indeed, many regions around the world are already facing water scarcity, with the demand for water increasing due to pressures associated with population growth, urbanisation, and industrialisation.

In addition, conserving water also translates into financial savings for individuals, businesses, and governments, and reduced energy usage. Consequently, implementing water-efficient technologies and practices can reduce water bills, operational costs, and infrastructure investments for water supply and treatment.

In a domestic setting, existing techniques for reducing water usage include using devices which restrict the flow of water, such as water saving shower heads and “low-flow” taps which mix air into a water-flow to create the effect of full water-flow despite the water volume being reduced.

A difficulty with water restriction type devices is that they do not provide a user with an appreciation of the amount of water being used and so may create a false sense that water has been conserved. For example, since, in the case of a shower, the amount of water used depends on how long a shower is operated, extending the length of a shower will increase the amount of water used. In the case, of a water saving shower head, a user may require additional time to wash on account of the reduction in water flow, thus mitigating at least some of the water saving arising from using the water saving head.

Another example of an approach for reducing water usage includes using devices which are placed inline between a shower arm and a shower head and which provides to a user information concerning water flowing in a water path. One example of an inline type device is disclosed in US Patent Publication No. 20130333764. However, inline devices of the type described in US Patent Publication No. 20133033764 require semi-permanent installation and, once installed, are difficult to relocate to another shower or tap fitting. Such approaches require installation by a licensed plumber or electrical contractor which increases the cost and complexity of the installation—in many cases making it cost prohibitive.

It would be desirable to provide a device which addresses at least some of the above-described problems.

### SUMMARY

According to a first non-limiting aspect, provided is a fluid flow timing device, comprising:
attaching means for attaching the device to a structure having or in mechanical communication with a fluid conduit;
a power supply;
at least one vibration sensor for periodically acquiring one or more sensed values indicative of an instantaneous sensed vibration of the structure;
at least one processor for periodically processing a set of the one or more sensed values to determine whether the set of the one or more sensed values are indicative of the presence or absence of fluid flow in the fluid conduit, and controlling an operation of a timer module depending on the determination; and
output means for providing an output signal indicating a status of the timer module.

In non-limiting embodiments, the at least one vibration sensor is a three-axis accelerometer having x, y and z axes and wherein the sensed values include x, y, z axis values of acceleration.

In non-limiting embodiments, the at least one processor has a normal power mode and a reduced power mode (such as a sleep mode), and the at least one processor periodically transitions from the reduced power mode to the normal power mode to process the set of one or more sensed values and control the operation of the timer module depending on the determination. An advantage of operating the at least one processor in this way is that power consumption of the device may be reduced.

Transition from the reduced power mode to the normal power mode may be initiated by the vibration sensor acquiring a predetermined number of the of one or more sensed values indicative of a sensed vibration attributable to fluid flow in the fluid conduit or it may be time-based.

In non-limiting embodiments, the device further includes a means for providing a signal for initiating transition of the at least one processor from the reduced power mode to the normal power mode at a fixed time interval which exceeds a time interval at which the vibration sensor periodically acquires one or more sensed values indicative of an instantaneous sensed vibration attributable to fluid flow in the fluid conduit. In other words, in non-limiting embodiments the transition from the reduced power mode to the normal power mode occurs at a lower frequency than the sampling frequency at which the vibration sensor periodically acquires one or more sensed values indicative of an instantaneous sensed vibration attributable to fluid flow in the fluid conduit.

In non-limiting embodiments, the means for providing the signal for initiating the transition is the vibration sensor. For example, in non-limiting embodiments, the vibration sensor periodically acquires one or more sensed values at a sampling frequency of about 25 Hz, and the vibration sensor communicates a signal for initiating transition of the at least one processor from the reduced power mode to the normal power mode at about 1 second intervals.

In non-limiting embodiments, the device is removably attachable to the structure. For example, in non-limiting embodiments the device includes a housing for housing at least the power supply, the at least one vibration sensor, and the at least one processor, wherein the attaching means is attached to the structure, and the housing is removably attachable to the attaching means. One advantage of this arrangement is that it allows the housing to be removed for charging. Another advantage of this arrangement is that it allows for consistent location of the housing, and thus the at least one vibration sensor, relative to structure, which may provide a benefit in terms of processing the set of the one or more sensed values.

In non-limiting embodiments, the structure is a structure which provides a fluid conduit for water, and wherein the structure comprises:
a. a rigid shower arm; or
b. a flexible shower arm; or
c. a shower head; or
d. a tap; or
e. a hose; or
f. a faucet.

In non-limiting embodiments, the output means is configured to provide the output signal as wireless signal transmission for communication to a wireless signal receiver.

In non-limiting embodiments, the output means is configured to provide the output signal as an audible signal.

In non-limiting embodiments, the output means is configured to generate an output signal as a visual indication.

According to another non-limiting aspect of the present disclosure provided is a method of timing fluid flow in a fluid conduit, the method comprising:
providing a vibration sensor for periodically acquiring one or more sensed values indicative of an instantaneous sensed vibration of a structure having or in mechanical communication with the fluid conduit;
providing at least one processor for periodically processing a set of the one or more sensed values to determine whether the set of the one or more sensed values are indicative of the presence or absence of fluid flow in the fluid conduit and controlling operation of a timer module depending on the determination; and
providing an output means for outputting a signal indicating a status of the timer module.

Another non-limiting aspect of the present disclosure relates to a user device including an application program configured to process an output signal produced by operating a device according to non-limiting embodiments.

### BRIEF DESCRIPTION OF THE DRAWINGS

The terms Fig., Figs., Figure, and Figures are used interchangeably in the specification to refer to the corresponding figures in the drawings.

Non-limiting embodiments of the present disclosure will be discussed with reference to the accompanying drawings wherein:

FIG. 1 is a front perspective view of a fluid flow timer according to non-limiting embodiments according to the present disclosure;

FIGS. 2 and 3 show an example application of the fluid flow timer shown in FIG. 1;

FIG. 4 is a rear perspective view of the fluid flow timer shown in FIG. 1;

FIG. 5 is a front perspective view of the fluid flow timer shown in FIG. 1 shown with a display in active state;

FIG. 6 is a rear perspective view of a housing of the fluid flow timer shown in FIG. 1;

FIG. 7 is a simplified functional block diagram for a fluid flow timer according to non-limiting embodiments according to the present disclosure;

FIG. 8 is a network diagram illustrating example communication channels for use with a fluid flow timer according to non-limiting embodiments according to the present disclosure;

FIG. 9 is an illustrative flow diagram for the operation of a fluid flow timer according to non-limiting embodiments according to the present disclosure; and

FIG. 10 is another illustrative flow diagram for the operation of a fluid flow timer according to non-limiting embodiments according to the present disclosure.

In the following description, like reference characters designate like or corresponding parts throughout the figures.

### DETAILED DESCRIPTION

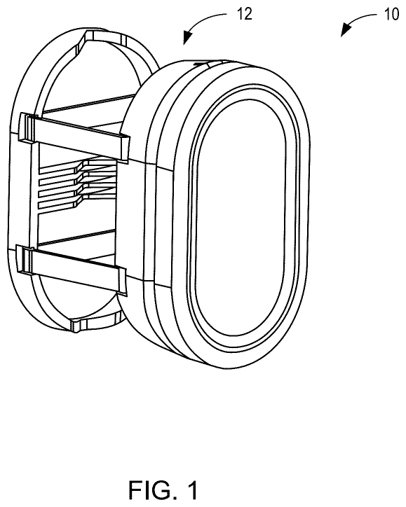

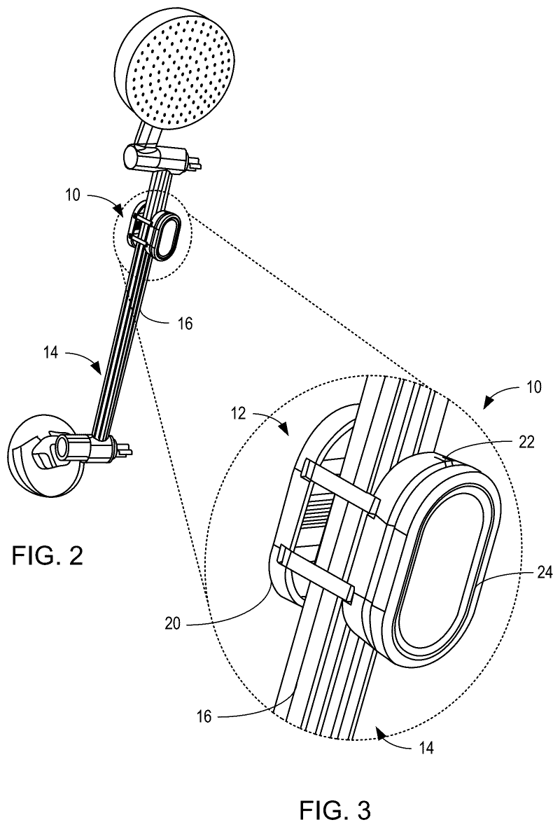

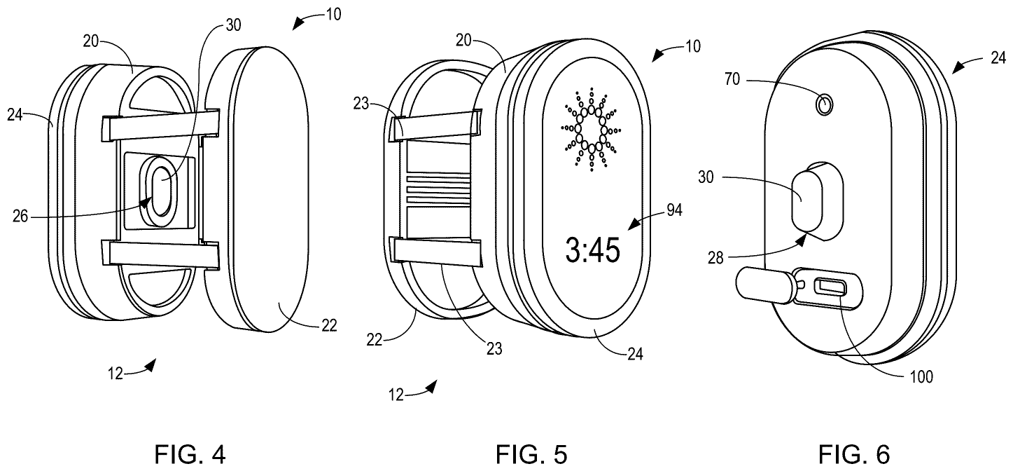

Referring initially to FIGS. 1 to 5, there is shown a fluid flow timing device 10 according to non-limiting aspects or embodiments. The fluid flow timing device 10 comprises attaching means 12 for attaching the device 10 to a structure 14 (ref. FIGS. 2 and 3) having an association with a fluid conduit for conveying a fluid.

In non-limiting embodiments, the device 10 is configured to acquire a set of one or more sensed values indicative of an instantaneous sensed vibration of the structure 14 and to periodically process the set of one or more sensed values to determine whether the set of one or more sensed values are indicative of the presence or absence of fluid flow in the fluid conduit. Operation of a timer module of the device 10 is then controlled depending on the determination. Control of the operation of the timer module may involve automatically initiating, continuing, and/or resetting a timer of the timer module depending on the determination. The timer module may comprise a countdown timer or a duration timer.

In non-limiting embodiments, the device 10 is configured to automatically control operation of the timer module depending on the determination of an indication of the presence of a fluid flow in the fluid conduit, such as by initiating a countdown timer of the timer module. However, in non-limiting embodiments, the device 10 is configured to automatically control the timer module depending on the determination of an indication of an absence of, or a reduction in, fluid flow (such as a stopped or reduced fluid flow) in fluid conduit in which a fluid flow should normally be present.

With reference to FIGS. 2 and 3, in the described embodiment, the structure 14 is a shower arm 16 and the device 10 is configured to automatically control operation of the timer module of the device 10 on detection of the indication of presence or absence of water flow through the shower arm so as to time a water flow associated with shower usage. However, it is possible that a device 10 according to non-limiting embodiments may be attached to other types of structures associated with a fluid conduit for a fluid flow, including water or other fluids. Examples of other structures include valves, pipes, hoses, elbows, tees, bushings, nipples, couplings, adapters, lines, tubing, taps, and faucets. Such structures may be rigid structures, semi rigid structures, or flexible structures.

It will thus be appreciated that although the illustrated example relates to the structure 14 in the form of a shower arm 16, a “structure” could be any fitting or object through which vibration caused by fluid flow through a fluid conduit propagates. In this respect, in non-limiting embodiments it is possible that such vibrations may be associated with fluid flow through a fluid conduit of the structure itself (such as a tube, pipe or hose), or they may be vibrations which propagate through a structure in direct or indirect mechanical communication with the fluid conduit.

One example of a structure in mechanical communication with a fluid conduit is shower cubicle tiling in mechanical communication with a pipe(s) conveying hot and/or cold water. Another example of a structure in indirect mechanical communication with the fluid conduit is a sink, bath or in mechanical communication with a faucet (being a fluid conduit) which conveys hot and/or cold water. Accordingly, it will be appreciated that in non-limiting embodiments it is possible that a device 10 may be attached, by suitable attaching means 12, to a surface of a structure in mechanical communication with the fluid conduit.

Returning now to FIGS. 2 and 3, in the illustrated embodiment, the device 10 is responsive to determining an indication of water flow in the shower arm 16 to automatically initiate and display a countdown timer of the timer module, whereupon on expiry of the countdown timer, the device 10 communicates an output indication (such as a visual and/or audible indication) to alert a user. In this respect, in this description, when the timer module is operating in a countdown operating mode it will be referred to as a “countdown timer”.

The countdown timer may have an associated fixed duration, and/or a user programmable duration, and/or a user selectable duration. Illustrative examples of durations include a 5 minute duration, a 10 minute duration and/or a 15 minute duration, although other durations may be used, programmed and/or selected. In this application, and as will be described in more detail following, an advantage of a device in accordance with non-limiting embodiments of the present disclosure is that, once the device 10 is installed, the countdown timer of the device 10 may be automatically controlled (eg. to initiate, and/or interrupt, and/or reset the countdown timer), responsive to the device 10 determining an indication of the presence or absence of water flow in the shower arm 16, without requiring a user to interact with the device 10 (such as by operating a switch).

Before continuing further, although the example that follows relates to an application in which the described device 10 is used to time water flow associated with shower usage, it is possible that non-limiting embodiments of the fluid flow timing device 10 may be used in other applications.

For example, it is possible that non-limiting embodiments of the present disclosure may be used to time fluid flow, or indeed the absence of fluid flow, in other domestic or commercial applications. Examples of other applications include:
Sensing and timing fluid flow associated with usage of a sink, bath, trough, tank or tub.
Sensing and timing fluid flow associated with usage of an irrigation system or device.
Sensing and timing a duration of a presence or absence of fluid flow in a fuel line, such as a diesel fuel line, a petrol fuel line, a gas fuel line or the like.
Sensing and timing changes in state of a fluid flow, such as a change in condition of a fluid flow from a flowing condition to a static condition and vice versa.

It will thus be appreciated that there are various applications for embodiments of the present disclosure.

Continuing now with reference to FIGS. 3 to 5, the illustrated attaching means 12 comprises a pair of clamping members 20, 22 which are secured about a section of the shower arm 16 by suitable means 23 (ref. FIG. 5), such as cable ties, resilient straps, hook and loop webbing, clips or the like. However, it will be appreciated that the configuration of the attaching means 12 may depend on the physical characteristics (for example, diameter and shape) of the structure to which the device 10 is to be attached.

In the illustrated embodiment, a housing 24 of the device 10 removably attaches to clamping member 20 in a keyed relationship. When attached in this way, the housing 24 is gripped by the clamp member 20 and a projection 28 (ref. FIG. 6) of the housing 24 is received within a correspondingly shaped socket 26 (ref. FIG. 4) of the clamp member 20. When the projection 28 is received within the correspondingly shaped socket 26, a surface 30 of the projection 28 is located in contacting relationship with the shower arm 16 (ref. FIGS. 2 and 3). By attaching the device 10 to the shower arm 16 in this way, vibrations attributable to fluid flow in the shower arm 14 are communicated to the surface 30 of the projection 28 and thus to the housing 24 of the device 10, whilst also allowing the housing 24 to be readily removed, such as for charging an internal power source of the device 10.

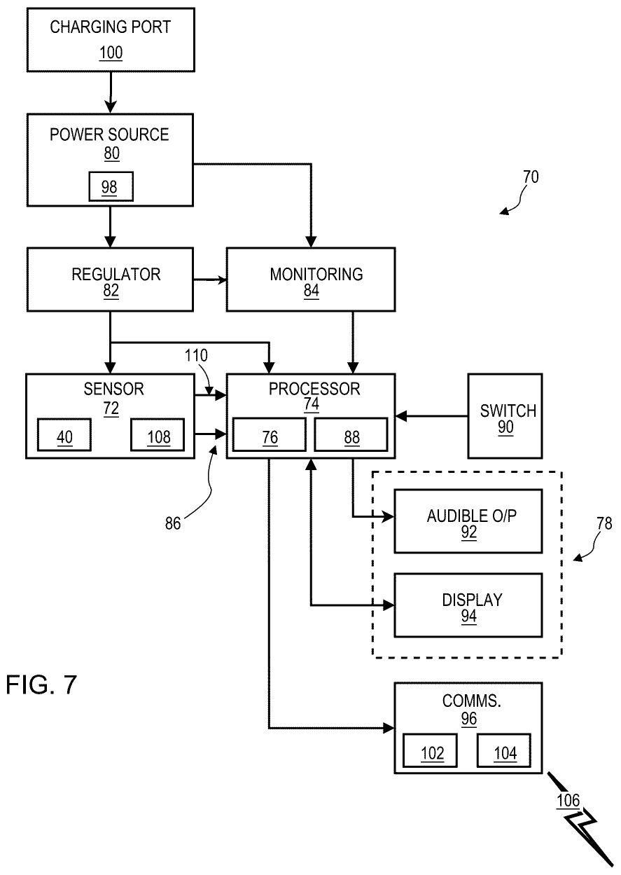

With reference now to FIG. 7 there is shown a simplified functional block diagram 70 of non-limiting embodiments of the device 10 according to non-limiting embodiments of the present disclosure. As shown, the illustrated device 10 comprises a vibration sensor 72, at least one processor 74 having an associated memory 76 programmed with a set of program instructions, at least one output means 78 and a power source 80 (and associated electronics comprising regulation circuitry 82 and monitoring circuitry 84). In the present case, the processor 74 is a BG22 Bluetooth low energy (LE) wireless SoC processor of the “Wireless Gecko Series 2” platform having a low-power ArmCortex®-M33 core (27 μA/MHz active, 1.2 μA sleep) an FPU. maximum clock of frequency of 76.8 MHZ, 352 KB of flash memory and 32 KB of RAM memory. Other suitable processors would be known to a skilled person.

In use, when the device 10 is attached to a structure 14, vibrations in the structure 14 (ref. FIG. 2) are communicated to the device 10 and sensed by the least one vibration sensor 72 of the device 10. Vibration sensor 72 periodically acquires one or more sensed values indicative of an instantaneous sensed vibration of the structure 14. In non-limiting embodiments, the vibration sensor 72 is a triaxial accelerometer having a measurement range of about +/−2 g and a suitable sampling frequency. One example of a suitable sampling frequency is a sampling frequency of about 25 Hz, although different sampling frequencies maybe used. One non-limiting example of a vibration sensor 72 is a 12-bit low power accelerometer such as the BMA400 3-axes ultra-low power accelerometer produced by Bosch Sensortec GmbH.

The at least one processor (MCU) 74 of the device 10 periodically receives, via interface 86, and processes a set of the one or more sensed values to control an operation of a timer module 88 depending on whether the set of the one or more sensed values are determined to indicate the presence or absence of fluid flow in the fluid conduit.

In the present case, the timer module 88 is a module which is implemented by the set of program instructions stored in the memory 76 of the least one processor 74. Control of the operation of the timer module 88 may involve initiating a timer of the timer module 88 having an associated duration or it may involve resetting or interrupting (such as by stopping) the timer depending on whether the processor determines that the set of the one or more sensed values are indicative of the presence or absence of fluid flow in the fluid conduit. The duration of the timer may be a fixed duration, and/or user programmable duration and/or it may be a duration which is selectable from a plurality of durations. In this respect, in non-limiting embodiments, at least some operating modes of the timer module 88 of the device 10 are selectable by suitable means. As will be explained in more detail below, in non-limiting embodiments, the device 10 also includes a user operated switch 90 which is operable to select operating settings and modes of the device 10.

Continuing with reference to FIG. 7, the at least one output means 78 is in communication with one or more outputs of the least one processor 74 to provide an output signal indicating a status of the timer module 88 during at least one operating mode of the timer module.

In the illustrated embodiment, the least one output means 78 comprises an audible output means 92 (such as a piezo electric buzzer) and/or a display 94. Other suitable output means may also be used. One example of another suitable output means is a Micro Mobile a vibrating motor. Another example of a suitable output means is a wireless transmitter, such as a radio frequency (RF) or optical transmitter, in data communication with a user device.

Audible output means 92 receives a signal from the at least one processor 74 to generate an audible alarm to indicate, for example, a time remaining for, or expiry of, the duration of the timer of the timer module 88 during a countdown operating mode. Display 94 comprises a graphics display for displaying, for example, a time remaining until expiry of the duration of the timer of timer module 88 when the timer is operating as a countdown timer. With reference to FIG. 5, in the present case display 94 is shown as a digital display (such as an LED or LCD display) indicating a countdown duration. However, it is possible that other types of displays could be used, such as a series of separate indicators (such as LED indicators) indicating a countdown sequence.

Continuing with reference to FIG. 7, power source 80 supplies a source voltage to the electronic components of the device 10 via conventional voltage regulation circuitry 82. In non-limiting embodiments, the power source 80 comprises one or more suitable batteries 98. One example of suitable batteries is rechargeable 3.7V lithium polymer batteries with in-built protection functions, such as, over charge protection, over discharge protection, over-current protection and/or short circuit protection, although other types of batteries may be used.

Battery monitoring circuit 84 is of a conventional type and monitors the charge status of the one or more batteries 98 during charging and/or discharging cycles. In the present case, during a charging cycle the one or more batteries 98 are connected to a charging source via a charging port 100, such as a USB-C type interface. However, it is possible that other charging configurations may be used. For example, in non-limiting embodiments it is possible that inductive charging may be used to charge the one or more batteries 98.

There is a communications module 96 for supporting wireless communication via a wireless communications link 106. Communications module 96 may comprise a transceiver 102 and an antenna 104 for communicating status and/or control signals using suitable wireless components. Although in the present case the device 10 includes a communications module 96, it is not essential that such a communications module 96 be provided. Nevertheless, including a communications module 96 may provide additional functionality and flexibility in operation, depending on the application.

Wireless components of the transceiver 102 may include hardware and/or software to modulate and/or demodulate communications signals according to pre-established transmission protocols. The wireless components may further have hardware and/or software instructions to communicate via one or more Wi-Fi and/or Wi-Fi direct protocols, as standardized by the Institute of Electrical and Electronics Engineers (IEEE) 802.11 standards. In non-limiting and exemplary embodiments, the wireless components may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad, 802.11ay). 800 MHz channels (e.g. 802.11ah). It should be understood that this list of communication channels in accordance with certain 802.11 standards is only a partial list and that other 802.11 standards may be used (e.g., Next Generation Wi-Fi, or other standards).

In non-limiting embodiments, non-Wi-Fi protocols may be used for communications between the device 10 and a user device 212, such as Bluetooth, dedicated short-range communication, Ultra-High Frequency (UHF) (e.g. IEEE 802.11af, IEEE 802.22) or other data packet based wireless communications. The wireless components may include any known transceiver suitable for communicating via the communications protocols. The wireless components may further include a low noise amplifier (LNA), additional signal amplifiers, an analog-to-digital (A/D) converter, one or more buffers, and digital baseband.

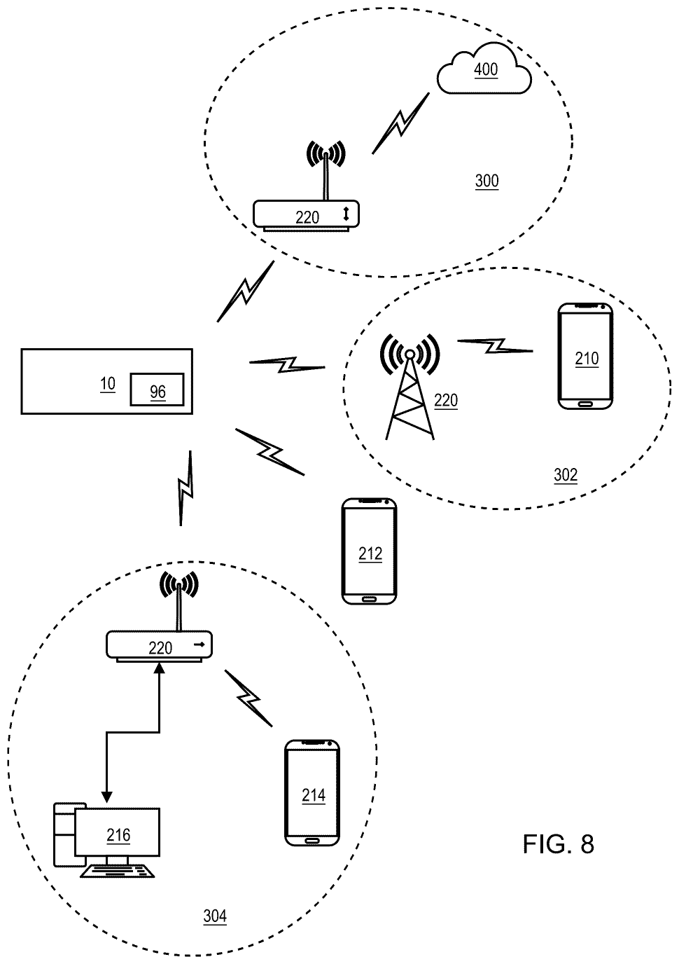

With reference now to FIG. 8, communications module 96 may support wireless communication with a user device, such as user devices 210, 212, 214, and/or 216 and/or with the cloud 400 via a suitable wireless communications network, such as wireless network 300, 302 and/or 302 including one or one or more access points(s) 220, which may communicate in accordance with IEEE 802.11 communication standards.

User device(s) 210, 212, 214, and/or 216 may be mobile devices that are non-stationary (e.g., not having fixed locations) or may be stationary devices. User devices 210, 212, 214 and/or 216 and access points 220 may include any suitable transceiver for transmitting and/or receiving wireless signals in the bandwidth and/or channels to facilitate communicating with the device 10. In non-limiting embodiments, a user device may include one or more computer systems, such as computer system 216.

Communications networks 300, 302, and/or 304 may include, but not be limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 300, 302 and/or 304 may include, for example, global networks (e.g., the Internet), wide area networks (WANs), or local area networks (LANs). In addition, any of the communications networks 300, 302, and/or 304 may include any type of medium over which network traffic may be carried including, but not limited to radio frequency communication mediums, ultra-high frequency communication mediums, satellite communication mediums, or any combination thereof.

One or more illustrative user device(s) 210, 212, 214, and/or 216 may be operable by one or more user(s). For example, user device(s) 210, 212, 214, and/or 216 may include, a user equipment (UE), a station (STA), an access point (AP), a software enabled application program, a personal computer (PC), a wearable wireless device (e.g., bracelet, watch, glasses, ring, etc.), a desktop computer, a mobile computer, a laptop computer, a notebook computer, a tablet computer, a server computer, a handheld computer, a handheld device, an internet of things (IoT) device. Other devices, including smart devices such as smart washing machines, smart irrigation controllers, smart water heaters, smart home controllers, smart dishwashers and the like may also be included in this list.

User device(s) 210, 212, 214, and/or 216 execute an application program interface (API) which uses information received from the device 10 and which provides information for communication to the device 10, to perform various actions. Non-limiting examples of such actions include displaying status information (such as the status of the batteries 98 of device 10) to a user of the user device 210, 212, 214, and/or 216, controlling the configuration, settings, operating mode and/or configuration of the device 10 (such as, a timer setting for timer module 88, and/or a brightness setting of the display 94, and/or a volume setting of audible output 92 and/or communication settings for communication module 96), and/or performing software updates of the device. It will be appreciated that the API may be configured to perform a variety of different actions, including actions which are specific for the application of the device 10 in terms of the type of fluid flow being sensed and/or the type of structure 14.

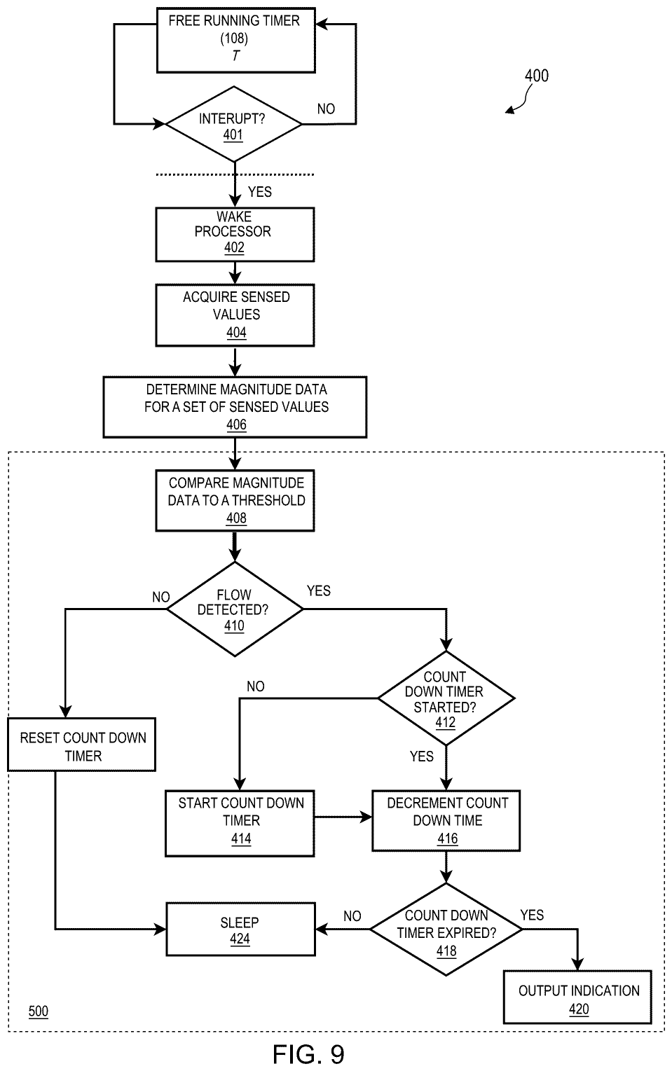

The operation of the device 10 attached to a shower arm can be understood with reference to the flow diagram 400 of FIG. 9. Device 10 is attached to a shower arm and the processor 74 initially operates in a low or reduced power mode (such as a sleep mode) from which it is periodically woken by a timer 108 (ref. FIG. 7), at step 302, to acquire, at step 404, a set of sensed x, y, z values from the vibration sensor 72 which, in the present example, obtains samples at a sampling frequency of 25 Hz. In the illustrative example, the timer 108 is a programmable timer on-board the sensor 72 which provides, at step 401, an interrupt signal 110 (ref. FIG. 7) to the processor 74 at a 1 sec period, although other timers and/or other interrupt schemes could be used.

In the present case, the set of sensed x, y, z values are acquired by the vibration sensor 72 and stored in an internal “on-chip” FIFO buffer 40 (ref. FIG. 7) of the vibration sensor 72 until the at least one processor 74 (ref. FIG. 7) is periodically woken. In non-limiting embodiments, when the processor 74 is woken, at step 402, it acquires, at step 308, a set of stored sensed x, y, z values from the FIFO buffer 40 for storage in a local buffer on board the at least one processor 74 at step 406 for processing at step 406.

Before continuing further, since in the described example the sampling frequency is 25 Hz, it is to be noted that the x, y, z values could potentially be acquired from the vibration sensor 72 every 1/fs=0.04 s, instead of every second. However, in the present case, by storing the sensed x, y, z values in an internal FIFO buffer 40 and periodically waking the at least one processor 74 to acquire and store the sensed x, y, z values, power consumption is reduced. Furthermore, although in this example a sampling frequency of 25 Hz is used, it is possible that other sample rates may be used, including higher sampling frequencies. However, an advantage of a lower sampling rate is that power consumption may be reduced.

Having acquired and stored sensed x, y, z values from the internal FIFO buffer 40, the at least one processor 74 determines a set of resultant magnitudes derived from the each of the collected sensed x, y, z values using a rolling sliding window having a suitable window size.

In the present case, the rolling sliding window size is 120, although other sizes may be used. For each sensed x, y, z values in a respective window, a rate of change for each axis is determined by calculating a differential value x_{diff}, y_{diff}, z_{diff} for each axis as the difference between pairs of consecutively sampled x, y, z values of the window. Using a differential calculation removes DC offset from the sensed signal. In the present example, for each acquired sample of xᵢ, yᵢ, zᵢ values in a window of size n, the differential values for each axis are calculated as:

$${x}_{diff} = {x}_{i - 1} - {x}_{i}$$

$${y}_{diff} = {y}_{i - 1} - {y}_{i}$$

$${z}_{diff} = {z}_{i - 1} - {z}_{i}$$

Where: i is the i^{th} value of the set of values in the window where i=1 to n.

A resultant magnitude is then determined for the differential values for each axis of the sensed x, y, z values as:

$${M}_{i} = \sqrt{{x}_{diff}^{2} + {y}_{diff}^{2} + {z}_{diff}^{2}}$$

By way of example, if the i^{th} acquired x, y, z values from the sensor 72 are:
x=0.168
y=−0.368
z=0.924
and the (i−1)^{th} acquired values from the sensor 72 in the previous acquisition were:
x=0.165
y=−0.363
z=0.923.

The differential values for each axis are determined as:

$${x}_{diff} = 0.168 - 0.165 = 0 \text{.003}$$

$${y}_{diff} = - 0.368 + 0.363 = - 0.0 \; 05$$

$${z}_{diff} = 0.924 - 0.923 = 0.001$$

The resultant magnitude is then determined using the differential values for each axis as:

$${M}_{i} = \sqrt{0. {3}^{2} + {( - 0.005 )}^{2} + 0.00 {1}^{2}} = 0.00591$$

In the present case, an algorithm maintains a rolling window of 120 (ie., n=120) magnitude values Mᵢ. When a new or “current” magnitude value is determined, the “oldest” value in the window is discarded, and the new magnitude value is added. A sum of the n stored resultant magnitude values is then calculated and divided by the size n of the window to determine a “magnitude rolling sum” R at step 408, as follows:

$$R = \frac{1}{n} {\sum }_{i = 1}^{n} {M}_{i}$$

Where n is the size of the rolling window (which, in the present example is 120).

At step 408, the magnitude rolling sum value R for an instance of the window is compared with a threshold value Rₜₕᵣₑₛₕ to determine whether the magnitude rolling sum value R is indicative of a flow of fluid in the shower arm 16. In the present example, the comparison involves comparing the magnitude rolling sum value R with a threshold value Rₜₕᵣₑₛₕ which has been determined by way of a suitable calibration process, such that if R>Rₜₕᵣₑₛₕ fluid flow detection is indicated.

By way of a non-limiting example, if the rolling sum value R=0.31 and the threshold value Rₜₕᵣₑₛₕ=0.329, no fluid flow is detected. On the other hand, if the calculated rolling sum value R was larger than 0.329, fluid flow is detected.

Continuing now with reference to FIG. 9, in the event that the comparison at step 408 indicates that fluid flow is detected, the timer module 88 (ref. FIG. 7) of the processor 74 either initiates, at step 414, or decrements, at step 416, a countdown operation of the timer module 88. If, at step 418, it is determined that the countdown timer has an expired status, an output indication is generated, at step 420, by the processor 74 providing a signal to the at least one output means 78 (ref. FIG. 7), which could involve activating an alarm on audible output 92 or an indication on activating display 94, or both.

In this respect, although not shown in FIG. 9, display 94 could also receive a signal from the processor 74 to control the display 94 to indicate a status of a duration remaining on the countdown timer during a countdown operating mode. It is also possible that the at least one output means 78 could be activated to indicate specific intervals or periods of the countdown cycle. By way of example, if the countdown cycle is a 5 minute countdown cycle, the at least one output means 78 could be activated to indicate 1 minute remaining, or, for example, on 15 second intervals during the final 1 minute period of the 5 minute countdown cycle. If the countdown timer has not expired, the current value of the countdown timer of the timer module 88 is stored and the processor 74 returns to the sleep condition at step 424.

As outlined above, non-limiting embodiments of the present disclosure may implement a calibration process which determines a value for Rₜₕᵣₑₛₕ when the device 10 is attached to a structure 10, noting that in the present example Rₜₕᵣₑₛₕ is the threshold value used in the comparison undertaken at step 408 of the process depicted in FIG. 9 to determine whether the magnitude rolling sum value R determined for a respective set of sensed values is indicative of water flow.

An advantage of determining a value for Rₜₕᵣₑₛₕ when the device 10 is attached to a structure 14 is that the determined value of Rₜₕᵣₑₛₕ may vary according to the nature and/or type of structure to which the device 10 is attached and the vibrations which arise from fluid flow in that structure. For example, different values of Rₜₕᵣₑₛₕ may be determined for a rigid structure (such as a tubular metal shower arm) and a flexible structure (such as a flexible hose). In the present case, the value for Rₜₕᵣₑₛₕ is determined during a calibration process when the device 10 is attached to a structure 14 and a fluid flow is present in the structure. For example, if device was installed on the shower hose the sensed acceleration values, and thus Rₜₕᵣₑₛₕ, may be larger compared to if the device 10 was installed on a fixed shower head.

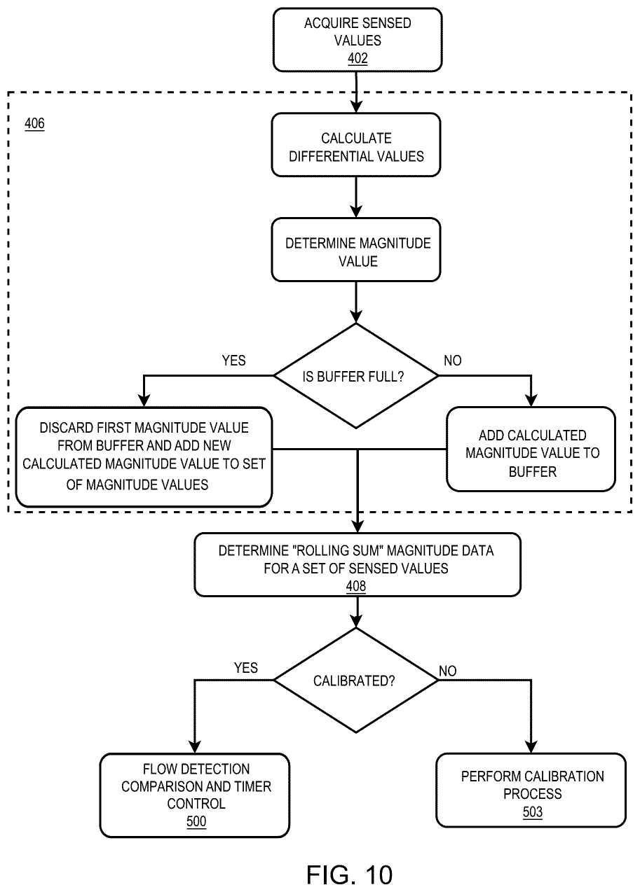

An illustrative example of the operation of the device 10 involving a calibration process 503 is shown in FIG. 10. In an illustrative calibration process, the device 10 is attached to a structure 14 and enabled for sensing whilst fluid is flowing in the shower arm 16. Device 10 then acquires and processes a plurality of rolling windows comprising n sets of sensed x, y, z values acquired from the sensor 72 to determine, for each rolling window, a magnitude rolling sum value R_{current} using the equation presented above for calculating the “magnitude rolling sum”.

Upon calculation of a magnitude rolling sum value for a “current” window, the value R_{current} is compared with the smallest “previous” magnitude rolling sum value Rₛₘₐₗₗₑₛₜ determined during the calibration process. If a “current” magnitude rolling sum value R_{current} is less than the smallest value Rₛₘₐₗₗₑₛₜ determined during the calibration process, the “current” magnitude rolling sum value R_{current} is selected as the new smallest value Rₛₘₐₗₗₑₛₜ. This process is repeated for a set of N sensed values of x, y, z spanning plural sliding windows. In one example N=600, so that once the 600th sensed values of x, y, z have been acquired and processed, the smallest magnitude rolling sum that has been calculated for the rolling windows comprising the 600 sensed x, y, z values are set as the threshold value that will be used for Rₜₕᵣₑₛₕ and the device 10 is calibrated for use.

Those of skill in the art would understand that the above-described information and signals may be represented using any of a variety of technologies and techniques. For example, data, instructions, commands, information, signals, bits, symbols, and chips may be referenced throughout the above description and may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the non-limiting embodiments disclosed herein may be implemented as electronic hardware, computer software or instructions, middleware, platforms, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the non-limiting embodiments disclosed herein may be embodied directly in hardware, in a software module executed by a processor, or in a combination of the two, including cloud-based systems. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or other electronic units designed to perform the functions described herein, or a combination thereof. Various middleware and computing platforms may be used.

In non-limiting embodiments the processor module comprises one or more Central Processing Units (CPUs) or Graphical processing units (GPU) configured to perform some of the steps of the methods. Similarly, a computing apparatus may comprise one or more CPUs and/or GPUs. A CPU may comprise an Input/Output Interface, an Arithmetic and Logic Unit (ALU) and a Control Unit and Program Counter element which is in communication with input and output devices through the Input/Output Interface. The Input/Output Interface may comprise a network interface and/or communications module for communicating with an equivalent communications module in another device using a predefined communications protocol (e.g. Bluetooth, Zigbee, IEEE 802.15, IEEE 802.11, TCP/IP, UDP, etc.). The computing apparatus may comprise a single CPU (core) or multiple CPU's (multiple core), or multiple processors. The computing apparatus may be a cloud based computing apparatus using GPU clusters, a parallel processor, a vector processor, or be a distributed computing device. Memory is operatively coupled to the processor(s) and may comprise RAM and ROM components, and may be provided within or external to the device or processor module. The memory may be used to store an operating system and additional software modules or instructions. The processor(s) may be configured to load and executed the software modules or instructions stored in the memory.

Software modules, also known as computer programs, computer codes, or instructions, may contain a number of source code or object code segments or instructions, and may reside in any computer readable medium such as a RAM memory, flash memory, ROM memory, EPROM memory, registers, hard disk, a removable disk, a CD-ROM, a DVD-ROM, a Blu-ray disc, or any other form of computer readable medium. In some aspects the computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. In another aspect, the computer readable medium may be integral to the processor. The processor and the computer readable medium may reside in an ASIC or related device. The software codes may be stored in a memory unit and the processor may be configured to execute them. The memory unit may be implemented within the processor or external to the processor, in which case it can be communicatively coupled to the processor via various means as is known in the art. In non-limiting embodiments, the processor may be implemented in hardware, firmware, or a combination of hardware and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Further, it should be appreciated that modules and/or other appropriate means for performing the methods and techniques described herein can be downloaded and/or otherwise obtained by computing device. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a computing device can obtain the various methods upon coupling or providing the storage means to the device. Moreover, any other suitable technique for providing the methods and techniques described herein to a device can be utilized.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

Please note that the following claims are provisional claims only, and are provided as examples of possible claims and are not intended to limit the scope of what may be claimed in any future patent applications based on the present application. Integers may be added to or omitted from the example claims at a later date so as to further define or re-define the scope.

What is claimed is:

1. A fluid flow timing device, comprising:
attaching means for attaching the device to a structure having or in mechanical communication with a fluid conduit;
a power supply;
at least one vibration sensor for periodically acquiring one or more sensed values indicative of an instantaneous sensed vibration of the structure;
at least one processor configured to periodically process a set of the one or more sensed values to determine whether the set of the one or more sensed values are indicative of the presence or absence of fluid flow in the fluid conduit, and control an operation of a timer module depending on the determination; and
output means for providing an output signal indicating a status of the timer module.

2. The fluid flow timing device according to claim 1, wherein the at least one vibration sensor is a three-axis accelerometer having x, y and z axes and wherein the sensed values include x, y, z axis values of acceleration.

3. The fluid flow timing device according to claim 1, wherein the at least one processor has a normal power mode and a reduced power mode, and wherein the at least one processor periodically transitions from the reduced power mode to the normal power mode to process the set of one or more sensed values and control the operation of the timer module depending on the determination.

4. The fluid flow timing device according to claim 3, wherein the transition from the reduced power mode to the normal power mode occurs at a lower frequency than the sampling frequency at which the vibration sensor periodically acquires one or more sensed values indicative of an instantaneous sensed vibration of the structure.

5. The fluid flow timing device according to claim 1, wherein the device is removably attachable to the structure.

6. The fluid flow timing device according to claim 1, wherein the structure provides a fluid conduit for water, and wherein the structure comprises at least one of the following:
a. a rigid shower arm;
b. a flexible shower arm;
C. a shower head;
d. a tap;
e. a hose;
f. a faucet;
or any combination thereof.

7. The fluid flow timing device according to claim 1, wherein the output means is configured to generate the output signal as wireless signal transmission for communication to a wireless signal receiver.

8. The fluid flow timing device according to claim 1, wherein the output means is configured to generate the output signal as an audible signal.

9. The fluid flow timing device according to claim 1, wherein the output means is configured to generate the output signal as a visual indication.

10. A method of timing fluid flow in a fluid conduit, the method comprising:
providing a vibration sensor for periodically acquiring one or more sensed values indicative of an instantaneous sensed vibration of a structure having or in mechanically communication with the fluid conduit;
providing at least one processor configured to periodically process a set of the one or more sensed values to determine whether the set of the one or more sensed values are indicative of the presence or absence of fluid flow in the fluid conduit and control operation of a timer module depending on the determination; and
providing an output means for outputting a signal indicating a status of the timer module.

11. A user device including an application program configured to process an output signal produced by operating a device according to claim 1.

12. A device comprising:
a memory programmed with a set of program instructions;
one or more processors coupled to the memory, the one or more processors configured to execute the set of program instructions, and cause the one or more processors to:
receive one or more sensed values indicative of an instantaneous sensed vibration of a structure having or in mechanically communication with a fluid conduit;
periodically process a set of the one or more sensed values to determine whether the set of the one or more sensed values are indicative of the presence or absence of fluid flow in the fluid conduit and controlling operation of a timer module depending on the determination; and
control an output means to provide an output a signal indicating a status of the timer module.

13. The fluid flow timing device according to claim 2, wherein the at least one processor has a normal power mode and a reduced power mode, and wherein the at least one processor periodically transitions from the reduced power mode to the normal power mode to process the set of one or more sensed values and control the operation of the timer module depending on the determination.

14. The fluid flow timing device according to claim 2, wherein the device is removably attachable to the structure.

15. The fluid flow timing device according to claim 3, wherein the device is removably attachable to the structure.

16. The fluid flow timing device according to claim 4, wherein the device is removably attachable to the structure.

17. The fluid flow timing device according to claim 2, wherein the structure provides a fluid conduit for water, and wherein the structure comprises at least one of the following:
a. a rigid shower arm;
b. a flexible shower arm;
c. a shower head;
d. a tap;
e. a hose;
f. a faucet;
or any combination thereof.

18. The fluid flow timing device according to claim 3, wherein the structure provides a fluid conduit for water, and wherein the structure comprises at least one of the following:
a. a rigid shower arm;
b. a flexible shower arm;
c. a shower head;
d. a tap;
e. a hose;
f. a faucet;
or any combination thereof.

19. The fluid flow timing device according to claim 4, wherein the structure provides a fluid conduit for water, and wherein the structure comprises at least one of the following:
a. a rigid shower arm;
b. a flexible shower arm;
c. a shower head;
d. a tap;
e. a hose;
f. a faucet;
or any combination thereof.

20. The fluid flow timing device according to claim 5, wherein the structure provides a fluid conduit for water, and wherein the structure comprises at least one of the following:
a. a rigid shower arm;
b. a flexible shower arm;
c. a shower head;
d. a tap;
e. a hose;
f. a faucet;
or any combination thereof.
